(19) United States
(12) Patent Application Publication
(10) Pub. No.: US 2012/0127645 A1
(43) Pub. Date: May 24, 2012

(54) Functional module for mounting on a mounting platform of a switch cabinet

(76) Inventors: Jose Quero, Bietigheim-Bissingen (DE); Steffen Lentmaier, Grossbottwar (DE); Bernd Mack, Sachsenheim (DE)

(21) Appl. No.: 13/299,605

(22) Filed: Nov. 18, 2011

(30) Foreign Application Priority Data
Nov. 18, 2010 (DE) 10 2010 044 137.6

(51) Int. Cl. G06F 1/16

(52) U.S. Cl. 361/679.4; 361/679.58

(57) ABSTRACT

A functional module for mounting on a mounting platform of a switch cabinet including a fastening arrangement which is complementary to a fastening arrangement disposed in the mounting platform and which make it possible to mount the functional module on the mounting platform, more particularly without the use of tools, a components carrier disposed at a distance from the fastening arrangement, on which components carrier electromechanical and/or electronic components can be installed, and connectors for the connection of process interface equipment and/or the electromechanical and/or electronic components, and a microprocessor based control unit, which is disposed in a region between the fastening means and the components carrier and is configured so as to process signals sent by the process interface equipment.

The invention relates to a functional module for mounting on a mounting platform of a switch cabinet.

WO 03/094314 A21 shows modules for mounting on a mounting platform of a switch cabinet. Each module comprises a components carrier, to which electromechanical and/or electronic components can be attached. Furthermore, connectors are provided at opposite ends of the components carrier for the purpose of connecting process interface equipment and the electromechanical and/or electronic components, and between the connectors at the opposite ends of the components carrier there are provided, on its reverse side, electrical conductors, which electrically interconnect corresponding contacts of the connectors at the opposite ends for the purpose of simplifying the wiring of the components present on the components carrier.

It is an object of the invention to provide a functional module based on the aforementioned modules and covering an increased performance range.

The invention achieves this object with a functional module as defined in claim 1. Preferred embodiments are subject matter of the subordinate claims, which are hereby declared to be part of the present description by reference.

The functional module of the invention, that is to say a module that provides a specified set of mechanical, electrical, and electronic functions available to a user, without the user having to modify or extend the module, is suitable for mounting on a mounting platform of a switch cabinet as designated in WO 03/094314 A2 with the reference sign 10, for example. The functional module comprises fastening means, for example in the form of lugs, which are complementary to fastening means on the mounting platform and make it possible to mount the functional module on the mounting platform particularly without the use of tools. The functional module also comprises a components carrier or a components board provided at a distance from the fastening means, to which carrier or board the electromechanical and/or electronic components, for example, relays, contactors, etc. can be attached, and connectors for the purpose of connecting process interface equipment, that is to say, actuators, sensors, motors, machines, installations, data transmission links, field buses etc., which are controlled by means of the functional module or if necessary by other functional modules or which exchange data with the functional module, and the electromechanical and/or electronic components. A microprocessor based or microcontroller based control unit of the functional module is disposed in a region between the fastening means and the components carrier and is configured to process signals sent by the process interface equipment in terms of the control and/or diagnosis of the process interface equipment and of the functional module itself. Compared with the modules described in WO 03/094314 A2, the functional module of the invention covers an increased performance range, such that retrofitting to this extent is no longer necessary.

According to a development, the functional module comprises a field bus interface unit, which is disposed in the region extending from the fastening means to the components carrier and is configured to form a field bus interface and to make I/O operation possible via the connectors for connecting the process interface equipment and the electromechanical and/or electronic components. The field bus interface can, for example, be an ARCNET interface, a CAN interface, a DeviceNet interface, an EtherCAT interface, an AS-I interface and/or a SERCOS interface.

According to a development, the field bus interface unit is formed on an associated board equipped with suitable ICs, it being possible to provide different boards for different field bus types, of which boards one that is suitable for the field bus used is disposed in the functional module.

According to a development, an energy supply unit is provided in the functional module, which unit is disposed in the region between the fastening means and the components carrier and is configured so as to distribute operating voltages and/or supply voltages in a suitable manner.

According to a development, the energy supply unit is formed on an associated board, which represents a wiring stage, that is to say, one in which prewiring is achieved, which would otherwise have had to be carried out manually during final wiring of the functional module with the process interface equipment.

According to a development, the microprocessor based control unit is formed on a board equipped with appropriate ICs, for example, a microprocessor IC.

According to a development, the field bus interface unit board, the energy supply unit board and the control unit board form parallel stages, which are disposed in an assembly chamber between the fastening means and the components carrier.

According to a development, a power electronics unit is provided which is disposed in the region between the fastening means and the components carrier and is configured for the purpose of providing switching and/or controlling functions on the process interface equipment in the form of consumers to be supplied with mains voltage, for example electric motors.

According to a development, the region between the fastening means and the components carrier is surrounded by substantially closed walls, which together with the components carrier form a chamber or housing, and the microprocessor based control unit, and/or the field bus interface unit, and/or the power electronics unit, and/or the energy supply unit are disposed in said chamber or housing, more particularly in any order.

The invention is described below with reference to the drawings, which illustrate preferred embodiments of the invention, and in which:

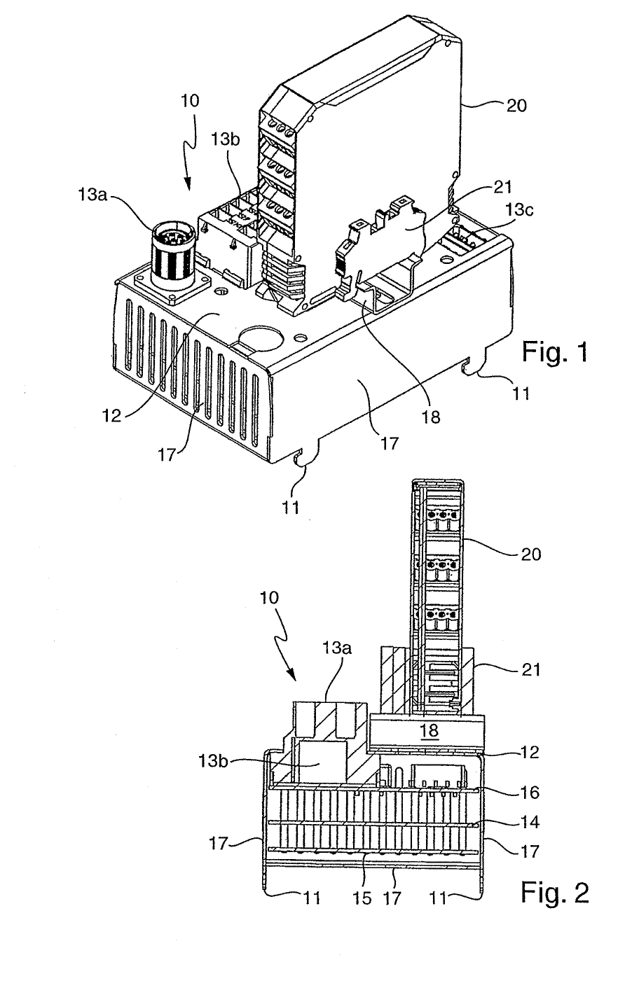

FIG. 1 is a perspective view of a functional module of the invention for mounting on a mounting platform of a switch cabinet, showing components disposed on said functional module and

FIG. 2 is a cutaway view of the functional module shown in FIG. 1.

FIG. 1 is a perspective view of functional module 10 of the invention for mounting on a mounting platform of a switch cabinet, such as is designated, for example, in WO 03/094314 A2 by the reference numeral 10, with components disposed thereon, for example, in the form of an electronic load relay 20 for three-phase networks and another component 21.

The functional module 10 comprises fastening means in the form of lugs 11, which are complementary to fastening means in the form of recesses in the mounting platform and which make it possible to mount the functional module 10 on the mounting platform without the use of tools. Furthermore, a components carrier in the form of a housing wall 12 is provided at a distance from the fastening means 11, on which the components 20 and 21 are attached by way of a cap rail 18, which is screwed to the components carrier or housing wall 12. Furthermore, connectors 13a, 13b and 13c are provided.

The round connector 13a serves to connect process interface equipment in the form of, for example, electric motors, sensors, actuators, apparatus, etc. The plug 13b serves as a connecting plug for further functional modules (not shown) or for an overriding control unit (not shown). By means of the plug 13b, the functional module 10 is connected, for example, to energy and data conductors, that is to say, for example, to AC current or three-phase current, 24V DC, a process grounding conductor, a neutral conductor, field bus lines, etc. Adjacent functional modules can be interconnected by the plug 13b in a simple manner line-by-line, since in the transverse direction of the plug 13b adjacently disposed contacts are electrically short-circuited and thus form an input or output contact. The connection of the components 20 and 21 to the functional module 10 is effected by means of the plug 13c.

A microprocessor based control unit in the form of a control unit board 14 (cf FIG. 2) is disposed or fixed in a region between the fastening means 11 and the components carrier 12 and configured so as to process signals sent by the process interface equipment in terms of a control function and/or a diagnostic function. The region between the fastening means 11 and the components carrier 12 is surrounded by walls 17, which together with the components carrier 12 form a chamber, in which the control unit board 14 is disposed.

In the chamber between the fastening means 11 and the components carrier 12 there is also provided a field bus interface unit in the form of a field bus interface unit board 15. The field bus interface unit board 15 implements a field bus interface according to a specified field bus standard and makes possible, inter alia, I/O operation via the connector 13b, by means of which the field bus is connected, and the connector 13c, by means of which the components 20 and 21 are controlled subject to the switching information transferred via the field bus. For example, a switched state of the electronic load relay 20 can be set via the field bus interface unit board 15, in which case the switching information is transferred via the plug 13b and the control signals are outputted via the plug 13c.

In the chamber formed between the fastening means 11 and the components carrier 12 there is also provided an energy supply unit in the form of an energy supply unit board 16, which is configured so as to distribute operating voltages and/or supply voltages, for example, 230V AC, three-phase current, a process grounding conductor, a common zero potential, 24V DC, etc., in a suitable manner between the connectors 13a to 13c via associated conducting paths. The energy supply unit board 16 forms a wiring stage, which makes subsequent wiring at least partly superfluous.

The field bus interface unit board 15, the energy supply unit board 16, the control unit board 14, and the components carrier 12 form parallel stages, which are installed in the chamber as illustrated in FIG. 2. It goes without saying that the boards can be installed in a different order or arranged differently.

In addition to the functional units or boards 14, 15, and 16 shown, other functional units may be provided, for example, a power electronics unit or power electronics board, which can be likewise disposed in the chamber. The power electronics unit can be configured so as to provide switching functions and/or control functions for the process interface equipment in the form of consumers to be supplied with mains voltage and may comprise, for example, contactors, power electronics semiconductors, etc.

The embodiments shown implement a mechanical mounting platform having integrated electronics. Different functional levels, stages, or blocks achieve different specific functions. Thus a functional block is provided in the form of a wiring stage serving to distribute energy. There is also provided a logical block for the purpose of effecting control and diagnosis. An I/O level serves to effect communication between commonly used commercial field buses. The functional blocks can be integrated in the space surrounded by the walls 17 or some may alternatively be disposed on the components carrier. A user can employ a fully equipped functional module or he or she can select individual functions suitable for his or her purpose.

The functional modules of the invention thus cover an increased performance range compared with conventional functional modules.

1. A functional module for mounting on a mounting platform of a switch cabinet, comprising:
fastening means which are complementary to fastening means disposed in said mounting platform and which make it possible to mount said functional module on said mounting platform, more particularly without the use of tools,
a components carrier disposed at a distance from said fastening means, on which components carrier electromechanical and/or electronic components can be installed, and
connectors for the connection of process interface equipment and/or said electromechanical and/or electronic components,
wherein
a microprocessor based control unit, which is disposed in a region between said fastening means and said components carrier and is configured so as to process signals sent by said process interface equipment.

2. The functional module as defined in claim 1, wherein a field bus interface unit is disposed in said region between said fastening means and said components carrier and is configured so as to form a field bus interface and makes I/O operation possible via said connectors for connecting said process interface equipment and said electromechanical and/or electronic components.

3. The functional module as defined in claim 2, wherein said field bus interface unit is formed on a corresponding board, wherein different boards are provided, in particular, for different field bus types.

4. The functional module as defined in claim 1, wherein an energy supply unit is disposed in said region between said fastening means and said components carrier and is configured so as to distribute operating voltages and/or supply voltages in a suitable manner.

5. The functional module as defined in claim 4, wherein said energy supply unit is formed on an appropriate board forming a wiring stage.

6. The functional module as defined in claim 1, wherein said microprocessor based control unit is formed on an appropriate board.

7. The functional module as defined in claim 3, wherein said field bus interface unit board, said energy supply unit board, and said control unit board form parallel stages.

8. The functional module as defined in claim 1, wherein a power electronics unit is disposed in said region between said fastening means and said components carrier and configured so as to effect switching functions and/or control functions on said process interface equipment, said process interface equipment being in the form of consumers to be supplied with a mains voltage.

9. The functional module as defined in claim 1, wherein said region between said fastening means and said components carrier is surrounded by substantially closed walls which together with the components carrier form a chamber, wherein said microprocessor based control unit, said field bus interface unit, said power electronics unit, and/or said energy supply unit are disposed in said chamber.
